(19) United States
(12) Patent Application Publication
(10) Pub. No.: US 2009/0045613 A1
(43) Pub. Date: Feb. 19, 2009

(54) ENERGY MANAGEMENT SYSTEM

(75) Inventor: MAURICE ROSS BALDWIN, TROY, MI (US)

Correspondence Address: BRINKS HOFER GILSON & LIONE, P.O. BOX 10395, CHICAGO, IL, 60610, US

(73) Assignee: Collins & Aikman Products Co., Southfield, MI (US)

(21) Appl. No.: 12/032,318

(22) Filed: Feb. 15, 2008

Related U.S. Application Data
(60) Provisional application No. 60/901,779, filed on Feb. 16, 2007.

(51) Int. Cl. B60R 21/02; B60R 21/04; B29C 39/00; B60R 21/05

(52) U.S. Cl. 280/750; 280/748; 296/187.05; 264/299

(57) ABSTRACT

An energy management system includes a bolster panel configured to attach to vehicle structure and a plurality of ribs connected to the bolster panel. Each rib is deflectable during a vehicle impact. The bolster panel and the plurality of ribs are unitary and formed as one piece. The plurality of ribs are arranged in a manner forming an energy absorption pattern that is progressive. A second energy management system includes a bolster panel configured to attach to vehicle structure, a plurality of ribs connected to the bolster panel, and a steering column support structure connected to the bolster panel. The bolster panel, ribs, and steering column support structure are unitary and formed as one piece. A method for creating the energy management system is also disclosed.

### CROSS-REFERENCE TO RELATED APPLICATIONS

This application claims the benefit of U.S. Provisional Application Ser. No. 60/901,779 filed on Feb. 16, 2007, entitled “ENERGY MANAGEMENT SYSTEM,” the entire contents of which are incorporated herein by reference.

### BACKGROUND

1. Field of the Invention

The present invention generally relates to energy management systems for use with motor vehicles. More specifically, the invention relates to energy management systems having bolster panels.

2. Description of Related Art

Motor vehicles have energy management systems, which help absorb passenger energy during vehicle impact events. These types of energy management systems have included crush cans, reinforcement plates, glove boxes, and bolster panels.

Bolster panels are typically attached to vehicle structure, such as the instrument panel or the vehicle cross-bar. Typical bolster panels have multiple parts and pieces, for example, metal ribs and reinforcements attached to a plastic bolster panel. A bolster panel for use in the passenger compartment of a vehicle also typically includes a surface covering or paint, in order to render the bolster panel aesthetically pleasing to occupants within a vehicle.

Bolster panels having multiple parts may be costly to produce. Furthermore, extra manufacturing steps, such as painting, are undesirable. However, many manufacturers of bolster panels have continued to use bolster panels having multiple parts and/or manufacturing steps, in order to meet safety standards and aesthetic standards.

In view of the above, it is apparent that there exists a need for an energy management system that meets manufacturing goals of simplicity and reduced cost, while maintaining a high level of safety and performance, as well as desirable aesthetic features.

### SUMMARY

The present invention provides an energy management system that maintains requisite safety standards without requiring multiple components, and while maintaining a look that is aesthetically pleasing to consumers.

In satisfying the above need, as well as overcoming the enumerated drawbacks and other limitations of the related art, the present invention provides an energy management system including a bolster panel configured to attach to vehicle structure and a plurality of ribs connected to the bolster panel. Each rib is deflectable during a vehicle impact, and the plurality of ribs are arranged in a manner forming an energy absorption pattern that is progressive. The bolster panel and the plurality of ribs are unitary and formed as one piece.

In another aspect, an energy management system includes a bolster panel configured to attach to vehicle structure, a plurality of ribs connected to the bolster panel, and a steering column support structure connected to the bolster panel. Each rib is deflectable during a vehicle impact. The bolster panel and the plurality of ribs are unitary and formed as one piece. The steering column support structure is also formed as one piece with the bolster panel.

In another aspect, a method for creating an energy management system is provided. The method includes melting plastic, adding gas or powder to the melted plastic, thereby creating a plastic-gas mixture, and pouring the mixture into a mold cavity. The mold cavity is provided having channels shaped to create a bolster panel having ribs extending therefrom. The channels are provided arranged in a manner configured to form ribs on the bolster panel that have an energy absorption pattern that is progressive.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of an energy management system embodying the principles of the present invention.

FIG. 2 is a side cross-sectional view of the energy management system of FIG. 1; and

FIG. 3 is a perspective view of a second embodiment of an energy management system embodying the principles of the present invention.

### DETAILED DESCRIPTION

Referring now to the drawings, an energy management system embodying the principles of the present invention is illustrated therein and designated at 10. The energy management system 10 includes a bolster panel 12 configured to attach to vehicle structure. A plurality of ribs 14 are connected to the bolster panel 12. Each rib 14 is deflectable during a vehicle impact. The bolster panel 12 and the plurality of ribs 14 are unitary and formed as one piece.

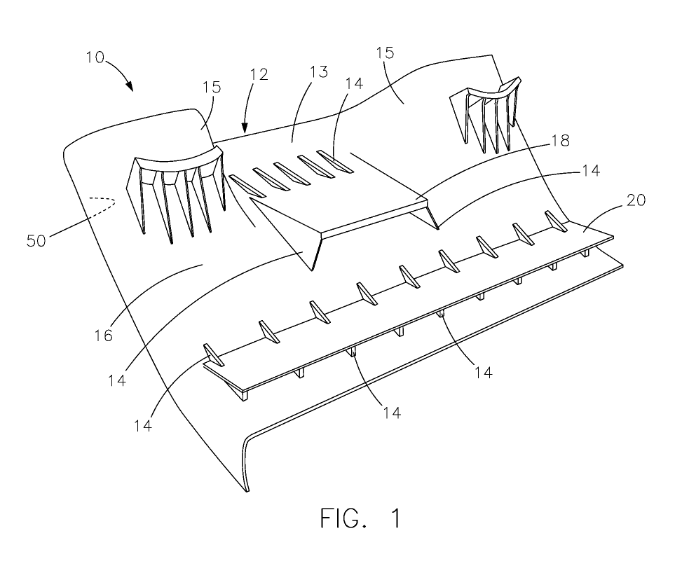

In the embodiment of FIG. 1, the plurality of ribs 14 are arranged in a manner forming an energy absorption pattern that is progressive, allowing for energy dissipation that is progressive, meaning that the ribs 14 progressively absorb energy over a period of time. For example, the plurality of ribs 14 are structured on the bolster panel 12 to deform or deflect in sequence. The ribs 14 of FIG. 1 are preferably configured to deflect or deform in series over time as force is transferred through from one rib 14 to another. Furthermore, the progressive energy absorption may include absorbing increasing amounts of force over time. During a vehicle impact event, a passenger's knees will likely strike the bolster panel 12, which will cause the bolster panel 12 and its ribs 14 to deflect. The present invention contemplates that the ribs 14 will deflect in sequence or series over time, where some ribs 14 will deflect earlier in time than other ribs 14, which will allow for progressive energy absorption, as further described herein.

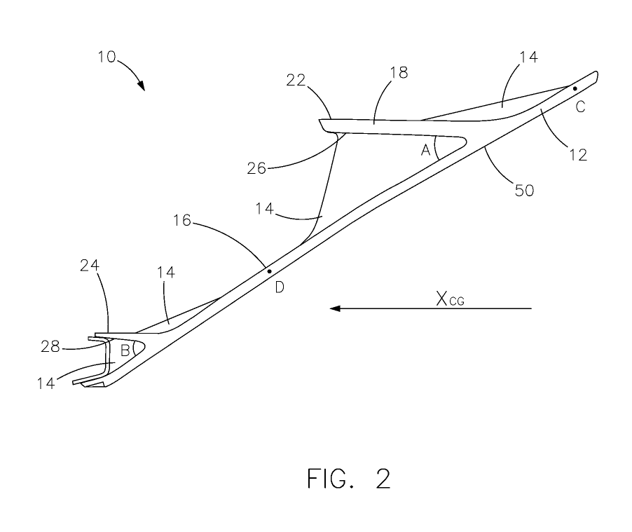

With reference to FIG. 2, a side cross-sectional view of the energy management system 10 of FIG. 1 is illustrated. The bolster panel 12 of the energy management system 10 has a panel surface 16. Cross-members 18, 20 protrude from the panel surface 16 at acute angles A, B. In this embodiment, the ribs 14 take the form of gussets. The ribs 14 extend between the panel surface 16 and one of the cross-members 18, 20. As can be seen in FIG. 2, some of the ribs 14 extend from the top side 22, 24 of each cross-member 18, 20, and some of the ribs 14 extend from the bottom side 26, 28 of each cross-member 18, 20.

The bolster panel 12 is configured to be installed into the passenger compartment of a vehicle in substantially the same orientation with respect to the vehicle axis, X_{CG}, as the orientation shown in FIG. 2. In other words, the panel surface 16 is located along a plane oriented at an acute angle with respect to the plane of the ground surface when the vehicle is parked on a flat surface. In this configuration, the cross-members 18, 20 lie substantially parallel with the longitudinal axis of the vehicle, X_{CG}.

It is contemplated that the bolster panel 12 could be rigidly attached to vehicle structure, or the bolster panel 12 could be loosely attached to vehicle structure. If the bolster panel 12 is loosely attached to vehicle structure, it could be attached with plastic wing nuts to the instrument panel (not shown), for example, allowing some movement of the bolster panel 12 with respect to the instrument panel.

The bolster panel 12 is configured to deform upon contact with the occupant of the vehicle when the occupant exerts a force upon the bolster panel 12 exceeding a predetermined threshold. In this embodiment, the energy management system 10 is configured for use on the driver's side of the vehicle, located opposite the knees of the driver. For example, in the present embodiment, the bolster panel 12 is particularly adapted to be attached in a passenger's compartment on a driver's side of a motor vehicle. Further, the bolster panel 12 is configured to have a steering column attached above the upper middle portion 13 of the bolster panel 12, between the upper side portions 15. It is also contemplated that the energy management system 10 could be installed on the passenger's side of the vehicle, or in the backseat. Furthermore, the energy management system 10 could be installed onto the exterior of a vehicle. For example, the energy management system could be installed as part of a bumper of a vehicle. The bolster panel would deform upon contact with an outside object that exerts a force upon the bumper if the force exceeded a predetermined threshold.

As previously mentioned, but inserted here for clarity purposes, the ribs 14, which could be gussets, are deflectable. When a force is exerted upon the bolster panel 12, such as in an impact event, the ribs 14 deflect in a manner allowing for progressive energy dissipation. The ribs 14 may deflect in sequence over time. For example, with reference to FIG. 2, if the energy management system encountered a force at point C, located above the top cross-member 18, the ribs 14 and cross-members 18, 20 would deflect in sequence from the top of the bolster panel 12 (such as from an occupant's knees striking the panel 112) on down to the bottom of the bolster panel 12.

More particularly, when a predetermined force is exerted at point C on the bolster panel 12, first the ribs 14 attached to the top side 22 of the upper cross member 18 would deflect, followed by the ribs 14 attached to the bottom side 26 of the upper cross member 18. If the force being exerted is great enough, the bolster panel 12 may continue to deflect, such that the ribs 14 attached to the top side 24 of the lower cross member 20 cross member deflect thereafter, followed by the ribs 14 attached to the bottom side 28 of the lower cross member 20. In addition, the surface 16 may deflect at a certain point within the sequence, for example, the surface 16 may deflect at point D after the ribs 14 attached to the upper cross member 18 deflect, but before the ribs 14 attached to the lower cross member 20 deflect. Thus, it can be understood that the deflection may be progressive in that portions of the bolster panel 12 deflect in sequence or series over time, or the deflection may be progressive in that a greater amount of force causes more of the portions of the bolster panel 12 to deflect. While shown as “vertically” progressive, it will be recognized that the ribs 14 and the members 18, 20 could be arranged for sequential deflection in a horizontal direction or in any desired path.

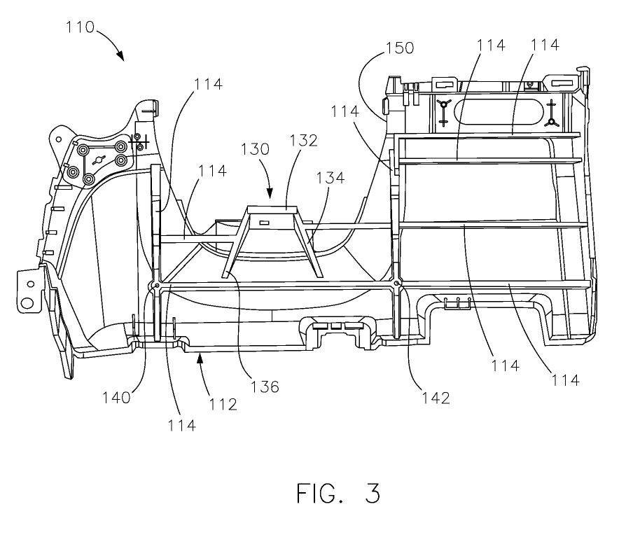

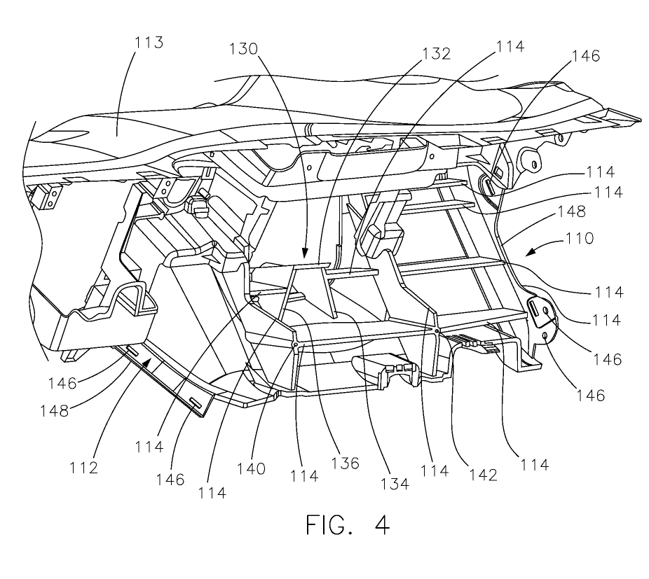

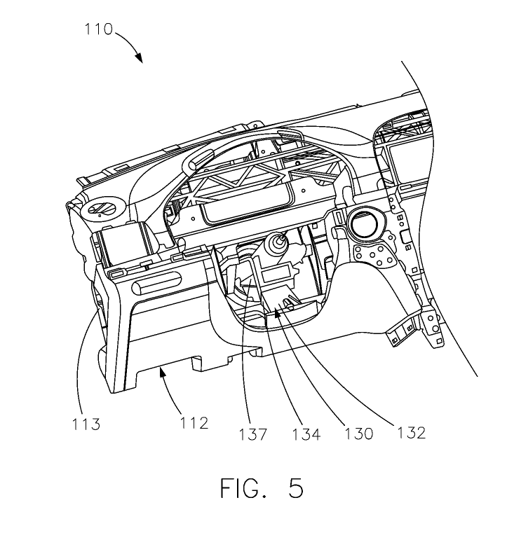

A second embodiment of an energy management system embodying the principles of the present invention is illustrated in FIGS. 3-5 and designated at 110. The energy management system 110 includes a bolster panel 112 configured to attach to vehicle structure 113. Several vertical and horizontal ribs 14 are connected to the bolster panel 112. The ribs 114 are deflectable during a vehicle impact. The ribs 114 and bolster panel 112 are unitary and formed as one piece. A steering column support structure 130 is also connected to the bolster panel 112, which is also unitary and formed as one piece with the bolster panel 112.

The steering column support structure 130 comprises three ribs 132, 134, 136, which support the steering column (not shown). In the preferred embodiment, one rib 132 of the steering column support structure 130 extends laterally and is preferably disposed along an axis that is substantially parallel to the lateral axis of the vehicle. When a force exceeding a predetermined threshold is exerted upon the steering column support structure 130, i.e., in an impact event, the steering column support structure 130 is deflected, which allows energy to be absorbed by the energy management system 110 through the steering column 137.

In the embodiment of FIGS. 3-5, the bolster panel 112 has interior support points 140, 142, which contact vehicle structure. These support points 140, 142 are points at which the bolster panel 112 is attached to vehicle structure 113. It should be understood that the bolster panel 112 could be attached to vehicle structure at additional points or fewer than two points 140, 142, including around the outer perimeter of the panel 112. For example, with reference to FIG. 4, vehicle structure 113 could be attached to some of the ribs 114, particularly the vertical ribs 114. Connection points 146 could also be provided at the sides 148. The bolster panel 112 also has impact points, which are the points at which the bolster panel 112 is designed to receive impact forces. It is preferable that the impact points are vertically higher than the support points 140, 142.

It is contemplated that the bolster panel 112 could be rigidly attached to vehicle structure 113, or the bolster panel 112 could be loosely attached to vehicle structure 113. If the bolster panel 112 is loosely attached to vehicle structure 113, it could be attached with plastic wing nuts to the instrument panel or other vehicle structure, for example, allowing some movement of the bolster panel 112 with respect to the instrument panel or other vehicle support structure.

Like the embodiment of FIGS. 1-2, the plurality of ribs 114 located on the bolster panel 112 could be arranged in a manner forming an energy absorption pattern that is progressive, allowing for progressive dissipation of energy. The ribs 114 could deform in sequence, or in series, over time. In addition or in the alternative, some ribs 114 could be configured to deflect upon receiving a first predetermined force, while other ribs 114 could be configured to deflect upon receiving a second predetermined force, wherein the second predetermined force is greater than the first predetermined force.

The energy management system 110 is preferably installed within the passenger compartment of a vehicle, preferably on the driver's side of the vehicle opposite the driver's knees. The energy management system 110 is configured to deform when the driver exerts a force upon the bolster panel 112 exceeding a predetermined threshold, such as the force that would occur during an impact event.

The energy management systems 10, 110 are preferably comprised of plastic having a microcellular core. The bolster panels 12, 112 have a Class “A” finish on their occupant-facing surfaces 50, 150, which obviates the need to cover the bolster panels 12, 112 with a covering material or paint the bolster panels 12, 112. The thickness of the bolster panels 12, 112 is preferably about six millimeters, although it also contemplated that the thickness could be other dimensions, such as about two millimeters to about ten millimeters.

A method for creating an energy management system is also contemplated by the present invention. The method includes melting plastic, adding gas or powder to the melted plastic, thereby creating a plastic-gas mixture, and pouring the mixture into a mold cavity. The mold cavity is provided having channels shaped to create a bolster panel 12, 112 having ribs 14, 114 extending therefrom. The channels are arranged in a manner configured to form ribs 14, 114 on the bolster panel 12, 112 having an energy absorption pattern that is progressive, which allows for progressive dissipation of energy, as hereinbefore described.

It is preferable that gas counter-pressure injection molding, particularly the Battenfeld process, be used to form the energy management system 10, 110, such as is disclosed in U.S. Pat. No. 4,381,272, which is herein incorporated by reference. It is contemplated that gas be added to melted plastic or that a powdered material be added to plastic, where the powdered material emits a gas when it is added to the hot plastic. As is known in the art, controlled venting should accompany the process. It is preferable that the gas to be used is nitrogen. The plastic is preferably polypropylene alloy (TPO) or an impact grade of ABS (acrylonitrile butadiene styrene) alloy, although any other suitable material could be used. By saturating the thermoplastic with an inert gas at high pressures, a uniform structure of small bubbles is created, i.e., a microcellular core, which is generally understood in the art. This process allows surface sink marks to be reduced or eliminated.

The channels in the mold structure are preferably provided having a configuration to form ribs that are structured to deform in a progressive manner. The channels could be provided having a configuration to form ribs that are structured to deform in sequence or to deform in series over time.

The method for creating the energy management system 10, 110 preferably includes installing the bolster panel 12, 112 into a passenger compartment of a vehicle without adding additional material to the bolster panel 12, 112 and without painting the bolster panel 12, 112.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I claim:

1. An energy management system for absorbing energy during a vehicle impact, the energy management system comprising:
a bolster panel configured to attach to vehicle structure; and
a plurality of ribs connected to the bolster panel, each rib being deflectable during the vehicle impact, the bolster panel and the plurality of ribs being unitary and formed as one piece, the plurality of ribs being arranged in a manner forming an energy absorption pattern that is progressive.

2. The energy management system of claim 1, wherein the plurality of ribs are structured on the bolster panel to deform in sequence.

3. The energy management system of claim 2, wherein the plurality of ribs are structured on the bolster panel to deform in series over time.

4. The energy management system of claim 1, wherein the bolster panel has a flat portion, and the energy management system further comprises at least one cross-member, the cross-member protruding from the flat portion at an acute angle.

5. The energy management system of claim 4, wherein the plurality of ribs extends between the flat portion and the least one cross-member.

6. The energy management system of claim 5, wherein a first set ribs of the plurality of ribs extends from a top side of the at least one cross-member and a second set of ribs of the plurality of ribs extends from a bottom side of the at least one cross-member.

7. The energy management system of claim 1, wherein the ribs are gussets.

8. The energy management system of claim 1, wherein the energy management system is comprised of plastic having a microcellular core.

9. The energy management system of claim 1, wherein the bolster panel has a Class “A” finish.

10. A method for creating an energy management system for absorbing energy during a vehicle impact, the method comprising:
melting plastic;
adding gas or powder to the melted plastic, thereby creating a plastic-gas mixture;
pouring the mixture into a mold cavity, the mold cavity comprising channels shaped to create a bolster panel having ribs extending therefrom, the channels being arranged in a manner configured to form ribs on the bolster panel having an energy absorption pattern that is progressive.

11. The method of claim 10, wherein the gas is provided as nitrogen.

12. The method of claim 10, wherein the plastic is provided as a one of polypropylene alloy (TPO) and an impact grade of ABS alloy.

13. The method of claim 10, further comprising the step of installing the energy management system into a passenger compartment of a vehicle without adding additional material to the bolster panel and without painting the bolster panel.

14. An energy management system for absorbing energy during a vehicle impact, the energy management system comprising:
a bolster panel configured to attach to vehicle structure;
a plurality of ribs connected to the bolster panel, each rib being deflectable during a vehicle impact, the bolster panel and the plurality of ribs being unitary and formed as one piece; and
a steering column support structure connected to the bolster panel, the steering column support structure being formed as one piece with the bolster panel.

15. The energy management system of claim 14, wherein the steering column support structure comprises three ribs, and wherein one rib of the three ribs is disposed along an axis substantially parallel to the horizontal pitch axis of the vehicle.

16. The energy management system of claim 14, wherein the steering column support structure is deflectable when a force exceeding a predetermined threshold is exerted upon the energy management system.

17. The energy management system of claim 14, wherein the bolster panel has at least two support points configured to contact vehicle structure and a plurality of impact points, the supports points being positioned vertically lower than the plurality of impact points.

18. The energy management system of claim 14, wherein the plurality of ribs are arranged in a manner forming an energy absorption pattern that is progressive.

19. The energy management system of claim 18, wherein the plurality of ribs are structured on the bolster panel to deform in sequence.

20. The energy management system of claim 18, wherein the plurality of ribs are structured on the bolster panel to deform in series over time.
